(19) United States
(12) Patent Application Publication
(10) Pub. No.: US 2007/0285598 A1
(43) Pub. Date: Dec. 13, 2007

(54) POLARIZING PLATE, METHOD OF MANUFACTURING THE SAME AND DISPLAY PANEL HAVING THE SAME

(76) Inventors: In-Sun Hwang, Suwon-si (KR); Joong-Hyun Kim, Suwon-si (KR); Seong-Yong Hwang, Seongnam-si (KR)

Correspondence Address: F. CHAU & ASSOCIATES, LLC, 130 WOODBURY ROAD, WOODBURY, NY, 11797, US

(21) Appl. No.: 11/737,210

(22) Filed: Apr. 19, 2007

(30) Foreign Application Priority Data
Jun. 9, 2006 (KR) 2006-51934

(51) Int. Cl. G02F 1/1335

(52) U.S. Cl. 349/96

(57) ABSTRACT

A polarizing plate includes a base substrate, a conductive lattice pattern and a light absorbing pattern. The base substrate has a first surface and a second surface located opposite to the first surface. The conductive lattice pattern is formed on the first surface in a stripe arrangement. The conductive lattice pattern reflects and/or polarizes light incident on the conductive lattice pattern. The light absorbing pattern is formed on the first surface and corresponds to the conductive lattice pattern. The light absorbing pattern absorbs at least a portion of light reflected on an arbitrary interface after being polarized by the conductive lattice pattern. Thus, an undesired polarization component of a light exiting through a polarizing plate may be reduced, thereby increasing a contrast ratio of a display panel.

### CROSS-REFERENCE TO RELATED APPLICATION

The present application claims priority to Korean Patent Application No. 2006-51934, filed on Jun. 9, 2006, the disclosure of which is incorporated by reference in its entirety.

### BACKGROUND OF THE INVENTION

1. Technical Field

The present disclosure relates to a polarizing plate, a method of manufacturing the polarizing plate and a display panel having the polarizing plate. More particularly, the present invention relates to a polarizing plate capable of reducing an undesired polarized light, a method of manufacturing the polarizing plate and a display panel having the polarizing plate.

2. Discussion of the Related Art

A liquid crystal display (LCD) apparatus can include an LCD display panel and a backlight assembly to provide the display panel with light. The LCD panel can include a thin-film transistor (TFT) substrate, a countering substrate including a color filter and a liquid crystal layer interposed between the TFT substrate and the countering substrate. Since the LCD panel is not self-emissive, a brightness of an image displayed by the LCD panel depends on the backlight assembly.

The LCD apparatus further can include polarizing plates disposed on and under the LCD panel so that the liquid crystal layer functions as a light shutter. The polarizing plate transmits light polarized in a predetermined direction. Particularly, the polarizing plate is theoretically capable of transmitting about 50% of light emitted from the backlight assembly. However, practically, about 43% of the light emitted from the backlight assembly passes through the polarizing plate because the polarizing plate can absorb the emitted light.

Furthermore, a manufacturing cost of the polarizing plate takes up about 25% to about 30% of a total manufacturing cost of the LCD panel having the polarizing plate, thereby increasing the manufacturing cost of the LCD apparatus.

When a conductive lattice pattern has a plurality of conductive lattice lines, which are arranged in a stripe type and have a nano-sized line width and a nano-sized pitch, the conductive lattice pattern has a reflecting capacity and a polarizing capacity substantially the same as a dual brightness enhancement film (DBEF). However, the conductive lattice pattern has a polarizing degree of about 1000:1, which is higher than a polarizing degree of the DBEF. Thus, the conductive lattice pattern is capable of replacing a conventional polarizing plate.

When the conventional polarizing plate is applied to an LCD panel with a twisted nematic (TN) liquid crystal layer and the LCD panel is in black, the LCD panel is inclined with respect to a longitudinal direction of a polarizer of the conventional polarizing plate by about 45 degrees. In addition, some portions of light incident into the LCD panel with the TN liquid crystal layer may be leaked. That is, some polarized light may be randomly emitted from the conventional polarizing plate.

When the conductive lattice pattern is used for the LCD panel with the TN liquid crystal layer in a condition substantially the same as a condition of the conventional polarizing plate, the light leakage increases. Thus, when the conductive lattice pattern is used as a polarizer, a contrast ratio of an LCD panel having the conductive lattice pattern may be reduced.

### SUMMARY OF THE INVENTION

Embodiments of the present invention provide a polarizer capable of reducing undesirably emitted randomly polarized light, a method of manufacturing the above-mentioned polarizer, and a display panel having the above-mentioned polarizer.

In an exemplary embodiment of the present invention, a polarizing plate includes a base substrate, a conductive lattice pattern and a light absorbing pattern. The base substrate includes a first surface and a second surface opposing the first surface. The conductive lattice pattern is formed on the first surface in a stripe arrangement. The conductive lattice pattern reflects and/or polarizes light incident on the conductive lattice pattern. The light absorbing pattern is formed on the first surface and corresponds to the conductive lattice pattern. The light absorbing pattern absorbs at least portions of light reflected on an arbitrary interface after being polarized by the conductive lattice pattern.

For example, the light absorbing pattern is disposed between the first surface and the conductive lattice pattern. The thickness of the light absorbing pattern may be about 10 to about 100 nm. The conductive lattice pattern may include a plurality of lattice lines and a pitch of the lattice lines adjacent to each other, and a width of each of the lattice lines may be about 100 to about 200 nm. Alternatively, the conductive lattice pattern may be disposed between the first surface and the light absorbing pattern.

In an exemplary embodiment of the present invention, a display panel includes a first substrate a second substrate and a liquid crystal layer. The first substrate includes a lower base substrate, a first conductive lattice pattern, a first light absorbing pattern and a plurality of pixels. The lower base substrate has a first surface and a second surface opposing the first surface. The first conductive lattice pattern is formed on the lower base substrate in a stripe arrangement. The first conductive lattice pattern reflects and/or polarizes light incident on the first conductive lattice pattern. The first light absorbing pattern is formed on the lower base substrate and corresponds to the first conductive lattice pattern. The pixels are formed on the lower base substrate. The second substrate includes an upper base substrate and a plurality of color filter parts. The upper base substrate has a third surface and a fourth surface opposing the third surface. The third surface faces the first surface. The color filter parts are formed on the upper base substrate and correspond to the pixels. The liquid crystal layer is interposed between the first and second substrates.

For example, the second substrate may further include a second conductive lattice pattern and a second light absorbing pattern. The second conductive lattice pattern is formed on the upper base substrate in a stripe arrangement. The second conductive lattice pattern reflects and/or polarizes light incident on the second conductive lattice pattern. The second light absorbing pattern is formed on the upper base substrate and corresponds to the second conductive lattice pattern.

For examples the pixels may be formed on the first surface with the first conductive lattice pattern and the first light absorbing pattern, or may be formed on the second surface. The second conductive lattice pattern and the second light absorbing pattern may be formed on the third surface with the color filter parts, or may be formed on the fourth surface.

In an exemplary embodiment of the present invention, there is provided a method of manufacturing a polarizing plate. In the method, a light absorbing layer is formed on a base substrate. A conductive layer is formed on the light absorbing layer. A photoresist pattern is formed in a stripe arrangement on the conductive layer. The conductive layer and the light absorbing layer are etched using the photoresist pattern as a mask to form a conductive lattice pattern and a light absorbing pattern, which correspond to the photoresist pattern.

For example, forming the photoresist pattern may be performed through a photolithography process or a laser interference lithography process.

According to exemplary embodiments of the present invention, a light absorbing pattern absorbs a portion of light that is reflected on an interface to irradiate the light absorbing pattern after being polarized by a conductive lattice pattern thereby reducing undesired polarization components of light exited from a polarizing plate.

### BRIEF DESCRIPTION OF THE DRAWINGS

Exemplary embodiments of the present invention can be understood in more detail from the following descriptions taken in conjunction with the accompanying drawings, in which:

FIG. 1 is a perspective view illustrating a polarizing plate according to an exemplary embodiment of the present invention;

FIG. 2 is a cross-sectional view taken along a line I-I′ of FIG. 1;

FIG. 3 is a cross-sectional view illustrating a display panel according to an exemplary embodiment of the present invention;

FIG. 4 is a cross-sectional view illustrating a display panel according to an exemplary embodiment of the present invention;

FIG. 5 is a cross-sectional view illustrating a display panel according to an exemplary embodiment of the present invention;

FIG. 6 is a cross-sectional view illustrating a display panel according to an exemplary embodiment of the present invention; and

FIGS. 7 to 10 are cross-sectional views illustrating a method of manufacturing a polarizing plate according to an exemplary embodiment of the present invention.

### DESCRIPTION OF THE EMBODIMENTS

Exemplary embodiments of the invention are described more fully hereinafter with reference to the accompanying drawings. This invention may, however, be embodied in many different forms and should not be construed as limited to the exemplary embodiments set forth herein.

Polarizing Plate

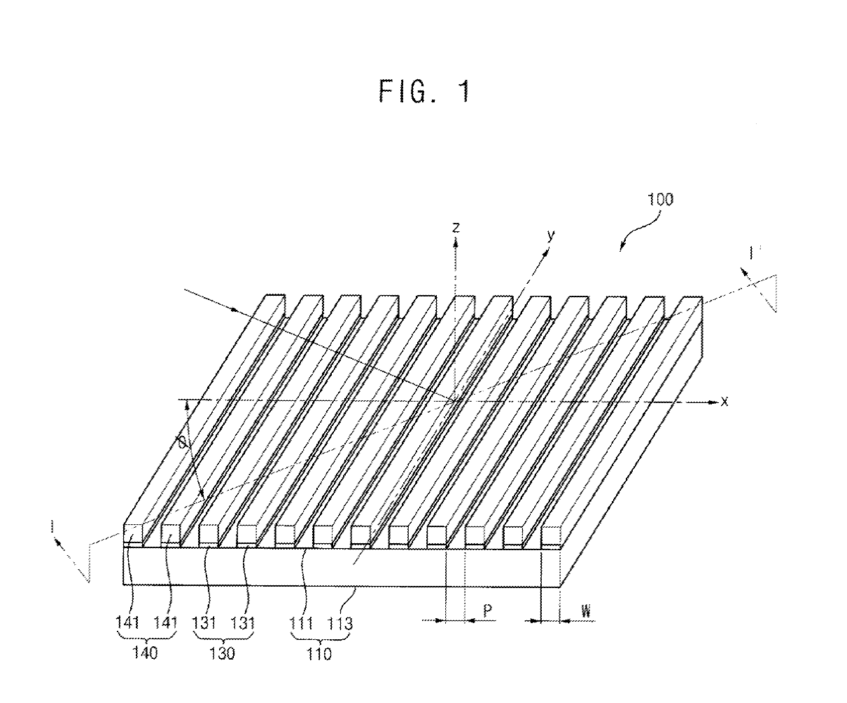

FIG. 1 is a perspective view illustrating a polarizing plate according to an exemplary embodiment of the present invention.

Referring to FIG. 1, a polarizing plate 100 includes a base substrate 110, a conductive lattice pattern 140 and a light absorbing pattern 130.

The base substrate 110 may include a glass that is optically isotropic. The base substrate 110 has a first surface 111 and a second surface 113 located opposite to the first surface 111.

The conductive lattice pattern 140 is formed on the first surface 111. The conductive lattice pattern 140 has a plurality of lattice lines 141. The lattice lines 141 are arranged in a stripe shape, particularly substantially in parallel with each other. The lattice line 141 may include, for example, a metal having a relatively high reflectivity such as aluminum (Al), aluminum-neodymium (Al—Nd) aluminum-molybdenum (Al—Mo), silver (Ag), copper (Cu), gold (Au) and/or molybdenum (Mo).

A polarizing capacity of the lattice lines 141 depends on a pitch P, a width W and a height of the lattice lines 141. The pitch P is defined as a gap between centers of the lattice lines 141 adjacent to each other. When the lattice lines 141 needs to have a polarizing capacity in a relatively great range of a wavelength, the pitch P may be more important. The pitch P may be smaller than a wavelength of light incident on the lattice lines 141 so that the lattice lines 141 may have a polarizing capacity. When the pitch P is greater than the wavelength of the incident light, the lattice lines 141 function as a diffracting lattice to diffract the incident light.

When the polarizing plate 100 functions as a substrate of a display panel, the lattice lines 141 may have a relatively great polarizing capacity with respect to a visible ray because the display panel displays an image using the visible ray.

A wavelength of the visible ray is about 400 to about 700 nm. Thus, the pitch P may be no more than about 400 nm. When the width W of the lattice line 141 is about 100 to about 200 nm, the pitch P may be about 100 to about 200 nm in view of a gap between the lattice lines 141. The thickness of the lattice line 141 may be about two to about three times greater than the width W.

The light absorbing pattern 130 absorbs portions of light that are reflected on an interface after being polarized by the conductive lattice pattern 140. The light absorbing pattern 130 is formed on the first surface 111 of the base substrate 110, and corresponds to the conductive lattice pattern 140. Thus, the light absorbing pattern 130 has a plurality of light absorbing portions 131 having a linear shape. The light absorbing portions 131 correspond to the lattice lines 141. A pitch P and a width W of the light absorbing portions 131 are substantially the same as the pitch P and the width W of the lattice lines 141.

The light absorbing pattern 130 may be formed between the first surface 111 and the conductive lattice pattern 140, or on the conductive lattice pattern 140. In an embodiment, the light absorbing pattern 130 is formed between the first surface 111 and the conductive lattice pattern 140.

The light absorbing pattern 130 may include, for example, a metal of which an optical density is no less than 3.5, for example, chrome (Cr) and/or a carbon-based organic material. Alternatively, the light absorbing pattern 130 may include a pigment capable of absorbing light.

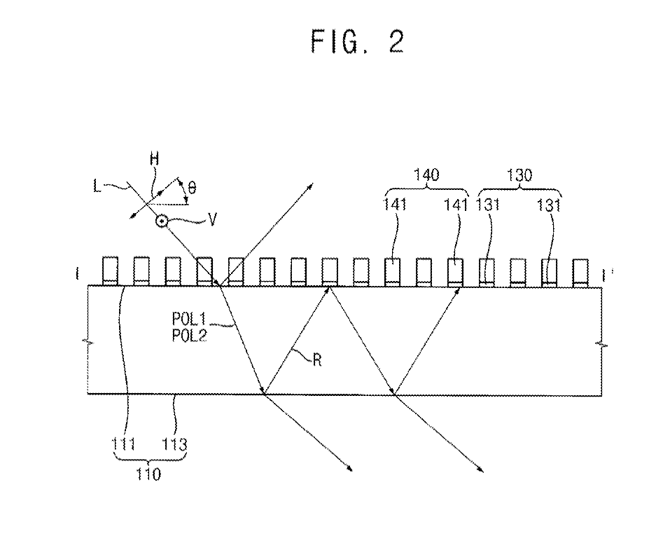

FIG. 2 is a cross-sectional view taken along a line I-I′ of FIG. 1.

Referring to FIGS. 1 and 2, the polarizing plate is explained more fully hereinafter using an x-y-z coordinating system. An x-axis is substantially perpendicular to a longitudinal direction of the lattice line 141. A y-axis is substantially parallel with the longitudinal direction of the lattice line 141. A z-axis is substantially perpendicular to the first surface 111 of the base substrate 110. A first angle φ is defined between the z-axis and the cross-section taken along the line I-I′.

A randomly polarized light L is incident into the polarizing plate 100 in a first direction slant with respect to the polarizing plate 100. A vector of the first direction projected on the first surface 111 is substantially parallel with the line I-I′.

The randomly polarized light L has a first light V and a second light H. An intensity of the first light V is defined as ‘V’. A polarization direction vector of the first light V is substantially perpendicular to the cross-section taken along the line I-I′. Since an angle between the cross-section and the x-axis is the first angle φ, an angle between the first light V and the y-axis is substantially the same as the first angle φ. The polarization direction vector of the first light V represented by the x-y-z coordinating system is (V sin φ, −V cos φ, 0).

An intensity of the second light H is defined as ‘H’. An angle between the first surface H and a polarization direction vector of the second light H is defined as a second angle θ. Thus, the polarization direction vector of the second light H is substantially perpendicular to the polarization direction vector of the first light V. The polarization direction vector of the second light H represented by the x-y-z coordinating system is (H cos θcos φ, H cos θ sin φ, H sin θ)

The randomly polarized light L is a visible ray, of which a wavelength is about 400 to about 700 nm. Since the pitch P of the lattice lines 141 is no more than about 20 nm, the randomly polarized light L is reflected and polarized by the conductive lattice pattern 140.

Particularly, a polarization component in each of the first and second light V and H, which is substantially parallel with the y-axis, is reflected by the conductive lattice pattern 140. Thus, the first and second light V and H passing through the conductive lattice pattern 140 are respectively changed to a first polarized light POL1 and a second polarized light POL2. The first and second polarized light POL1 and POL2 represented by the x-y-z coordinate system are (V sin φ, 0, 0) and (H cos θ cos φ, 0, H sin θ), respectively. Most of the first and second polarized light POL1 and POL2 exit through the second surface 113.

Alternatively, when the polarizing plate 100 does not include the light absorbing pattern 130, a remaining portion of the first and second polarized light POL1 and POL2 (hereinafter, referred to as a reflected light R) is repeatedly reflected on the first surface 111 and the second surface 113. A reflectivity and a transmittance at the first surface 111 and the second surface 113 may be varied according to polarization components of the first and second polarized light POL1 and POL2.

Thus, the reflected light R is repeatedly reflected on the first surface 111 and the second surface 113 to have a polarization component substantially parallel with the y-axis. Thus, a light exiting through the second surface 113 has the polarization component substantially parallel with the y-axis.

In an embodiment, the polarizing plate 100 includes the light absorbing pattern 130 disposed between first surface 111 and the conductive lattice pattern 140. Thus, when the reflected light R is incident on the first surface 111 between the light absorbing portions 131, the reflected light R is reflected and polarized again by the conductive lattice pattern 140 to have the polarization component substantially parallel with the y-axis.

When the reflected light R is incident on the light absorbing portions 131, the light absorbing portions 131 absorb a portion of the reflected light R, and a remaining portion of the reflected light R is reflected by the light absorbing portions 131. Thus, as the reflected light R is repeatedly reflected, the polarization component substantially parallel with the y-axis may be reduced. Thus, the polarization component, which is substantially parallel with the y-axis and exits through the second surface 113 may be reduced.

When most of the reflected light R is absorbed by the light absorbing pattern 130, the light exiting through the second surface 113 may be excessively reduced. Thus, the thickness of the light absorbing pattern 130 may be about 10 to about 100 nm so that a brightness of the light exiting through the polarizing plate 100 may be prevented from being excessively reduced.

Alternatively, the polarizing plate 100 may include a light absorbing layer instead of the light absorbing pattern 130. Here, the light absorbing layer does not have a pattern and is formed having a thickness of about 10 to about 100 nm on an entire region of the first surface 111.

Since the thickness of the light absorbing layer is relatively small, most of the first and second polarized light POL1 and POL2 polarized by the conductive lattice pattern 140 are transmitted through the light absorbing layer. Since the light absorbing layer is formed on the entire region of the first surface 111, an amount of the reflected light R absorbed by the light absorbing layer is greater than an amount of the reflected light R absorbed by the light absorbing pattern 130. Thus, the polarization component which is substantially parallel with the y-axis and exits through the second surface 113, may be reduced greatly.

Display Panel

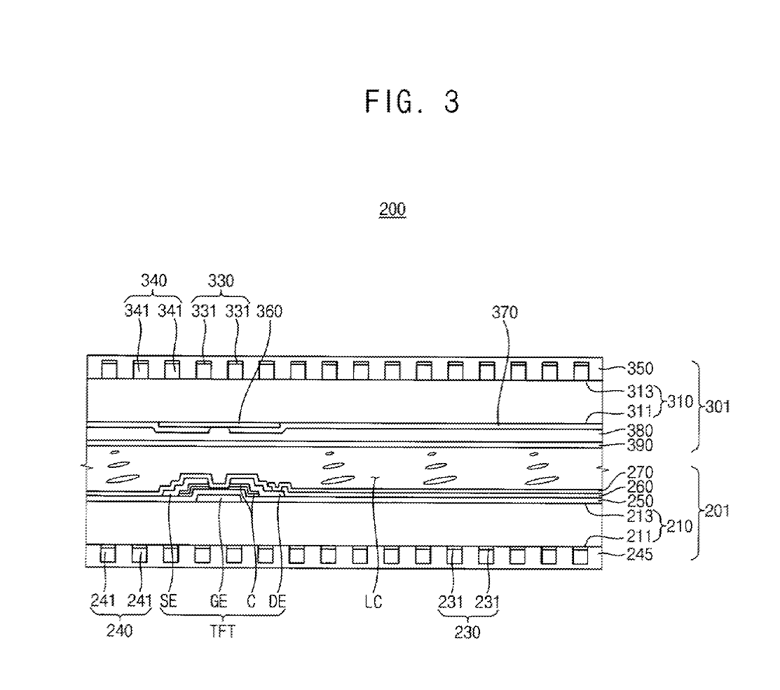

FIG. 3 is a cross-sectional view illustrating a display panel according to an exemplary embodiment of the present invention.

Referring to FIG. 3, a display panel 200 includes a first substrate 201, a second substrate 301 and a liquid crystal layer LC.

The first substrate 201 includes a lower base substrate 210, a first conductive lattice pattern 240, a first light absorbing pattern 230 and a plurality of pixels.

The lower base substrate 210, the first conductive lattice pattern 240 and the first light absorbing pattern 230 are substantially the same as those illustrated in FIGS. 1 and 2.

Thus, the lower base substrate 210 has a first surface 211 and a second surface 213 located opposite to the first surface 211.

The first light absorbing pattern 230 is formed on the first surface 211 and is arranged in a stripe shape. The thickness of the first light absorbing pattern 230 may be about 10 to about 100 nm. The first conductive lattice pattern 240 is formed on the first light absorbing pattern 230 and is arranged in a stripe shape to correspond to the first light absorbing pattern 230. Particularly, the first light absorbing pattern 230 is disposed between the first surface 211 and the first conductive lattice pattern 240. The first conductive lattice pattern 240 has a plurality of first lattice lines 241, and the first light absorbing pattern 230 has a plurality of first light absorbing portions 231.

The first substrate 201 may further include a first planarizing layer 245. The first planarizing layer 245 covers the first conductive lattice pattern 240. The first planarizing layer 245 may include a resin having a relatively great transmittance, such as, polycarbonate. The first conductive lattice pattern 240 and the first light absorbing pattern 230 are covered by the first planarizing layer 245 so that the first conductive lattice pattern 240 and the first light absorbing pattern 230 are prevented from getting damage, for example, a scratch.

A plurality of pixel areas is defined on the second surface 213 and is arranged in a matrix. Each of the pixels is disposed in each of the pixel areas. Each of the pixels includes a switching device TFT and a pixel electrode 270.

The switching device TFT includes a gate electrode GE, a gate insulating layer 250, a semiconductor layer C, a source electrode SE and a drain electrode DE. A plurality of gate lines is formed on the second surface 213. The gate electrode GE is extended from the gate line. The gate insulating layer 250 covers the gate lines and the gate electrode GE. The semiconductor layer C is formed on the gate insulating layer 250 corresponding to the gate electrode GE. A plurality of source lines crossing the gate lines is formed on the gate insulating layer 250. The source electrode SE is extended from the source line. The source and drain electrodes SE and DE apart from each other are formed on the semiconductor layer C. Here, the source and drain electrodes SE and DE face with each other.

The first substrate 201 may further include a passivation layer 260. The passivation layer 260 covers the lower base substrate 210 having the switching device TFT. The pixel electrode 270 is formed in each of the pixel areas and is electrically connected to the drain electrode DE that functions as an output electrode of the switching device TFT.

The second substrate 301 includes an upper base substrate 310 and a plurality of color filter parts 370. The upper base substrate 310 may include, for example, glass that is optically isotropic and substantially the same as that of the lower base substrate 210. The upper base substrate 310 has a third surface 311 and a fourth surface 313 located opposite to the third surface 311. The third surface 311 faces the second surface 213.

The second substrate 301 may further include a light blocking layer 360, an overcoating layer 380, a common electrode 390, a second conductive lattice pattern 340, a second light absorbing pattern 330 and a second planarizing layer 350.

The light blocking layer 360 is formed on the third surface 311 and has a plurality of openings corresponding to the pixel areas. The third surface 311 is exposed through the openings. Each of the color filter parts 370 is formed in each of the openings. The color filter parts 370 may include for example, a red color filter, a green color fitter and a blue color filter. The overcoating layer 380 covers the color filter parts 370 and the light blocking layer 360 to compensate a height difference between the color filter parts 370 and the light blocking layer 360. The common electrode 390 is formed on the overcoating layer 380.

In an embodiment, the second light absorbing pattern 330 is arranged in a stripe shape and is formed on the fourth surface 313. The second conductive lattice pattern 340 is disposed between the fourth surface 313 and the second light absorbing pattern 330, and is arranged in a stripe shape to correspond to the second light absorbing pattern 330. The thickness of the second light absorbing pattern 330 may be about 10 to about 100 nm. The second conductive lattice pattern 340 has a plurality of second lattice lines 341, of which a width and a pitch are substantially the same as those of the first conductive lattice pattern 240.

Polarization directions of the first lattice lines 241 and the second lattice lines 341 may be varied according to a type of the display panel 200, particularly, a type of the liquid crystal layer LC interposed between the first substrate 201 and the second substrate 301. For example, when the liquid crystal layer LC includes a twisted nematic (TN) liquid crystal or a super twisted nematic (STN) liquid crystal, the polarization directions of the first and second lattice lines 241 and 341 may be in a cross-Nicol arrangement so that the polarization direction of the first lattice lines 241 is substantially perpendicular to the polarization direction of the second lattice lines 341.

The second planarizing layer 350 covers the second light absorbing pattern 330 to protect the second conductive lattice pattern 340 and the second light absorbing pattern 330.

In an embodiment, a polarized light polarized by the first conductive lattice pattern 240 is defined as a P-polarized light. The polarized light is reflected on an interface to become a non-polarized light, and the non-polarized light is defined as an S-polarized light.

A randomly polarized light incident on the first surface 211 through the first planarizing layer 245 passes through the first conductive lattice pattern 240 to be changed to the P-polarized light. Most of the P-polarized light exits through the pixel electrode 270 toward the liquid crystal layer LC. A remaining portion of the P-polarized light is reflected on interfaces among the second surface 213, the gate insulating layer 250, the passivation layer 260 and the pixel electrode 270. The light reflected on the interfaces becomes a randomly polarized light having an S-polarization component, and then is incident on the first surface 211.

The first light absorbing pattern 230 absorbs a portion of the light reflected on the interfaces. Thus, the S-polarized light exiting through the pixel electrode 270 toward the liquid crystal layer LC may be reduced. Particularly, an undesired polarization component of the light exiting through the pixel electrode 270 toward the liquid crystal layer LC, which is different from a polarization component desired to be polarized by the first conductive lattice pattern 240, may be reduced.

When the TN liquid crystal or the STN liquid crystal is twisted, a polarization axis of the P-polarized light incident into the liquid crystal layer LC rotates so that the P-polarized light changes into the S-polarized light. The S-polarized light exited through the liquid crystal layer LC passes through the third surface 311 to be incident on the fourth surface 313. The S-polarized light incident on the fourth surface 313 passes through the second conductive lattice pattern 340 arranged in the cross-Nicol with respect to the first conductive lattice pattern 240.

Most of the S-polarized light passed through the fourth surface 313 moves through the second planarizing layer 350. A remaining portion of the S-polarized light is reflected on a surface of the second planarizing layer 350 to become a randomly polarized light having a P-polarization component. A portion of the randomly polarized light having the P-polarization component is absorbed by the second light absorbing pattern 330 formed on the second conductive lattice pattern 340. Thus, an undesired P-polarization component of the light exiting through the second planarizing layer 350 may be reduced.

When the TN liquid crystal or the STN liquid crystal is not twisted, the P-polarized light incident into the liquid crystal layer LC passes through the third surface 311 to be incident on the fourth surface 313. The polarization axis of the P-polarized light is not changed while the P-polarized light passes through the liquid crystal layer LC. The P-polarized light incident on the fourth surface 313 is reflected by second conductive lattice pattern 340 arranged in the cross-Nicol with respect to the first conductive lattice pattern 240.

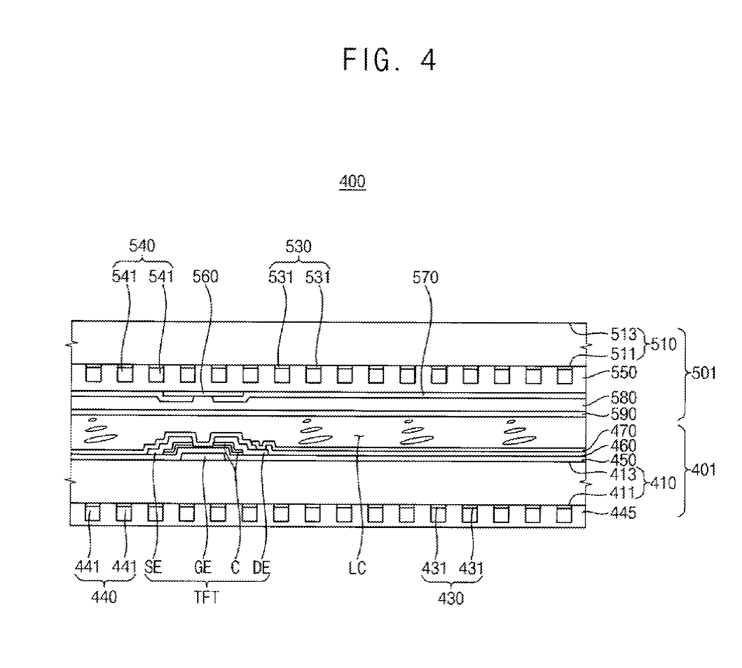

FIG. 4 is a cross-sectional view illustrating a display panel according to an exemplary embodiment of the present invention.

Referring to FIG. 4, a display panel 400 includes a first substrate 401, a second substrate 501 and a liquid crystal layer LC.

The display panel 400 is substantially the same as the display panel illustrated in FIG. 3 except for the second substrate 501.

The second substrate 501 includes an upper base substrate 510, a second light absorbing pattern 530, a second conductive lattice pattern 540, a second planarizing layer 550, a light blocking layer 560, a plurality of color filter parts 570 an overcoating layer 580 and a common electrode 590. The second substrate 501 is substantially the same as the second substrate illustrated in FIG. 3 except for dispositions of the second light absorbing pattern 530, the second conductive lattice pattern 540 and the second planarizing layer 550.

In an embodiment, the second conductive lattice pattern 540 is arranged in a stripe shape and is formed on a third surface 511 of the upper base substrate 510. The second light absorbing pattern 530 is disposed between the third surface 511 and the second conductive lattice pattern 540, and is arranged in a stripe shape to correspond to the second conductive lattice pattern 540.

The second planarizing layer 550 covers the second conductive lattice pattern 540.

The light blocking layer 560 is formed on the second planarizing layer 550 and has a plurality of openings through which the second planarizing layer 550 is exposed. Each of the color filter parts 570 covers each of the openings. The overcoating layer 580 covers the color filter parts 570 and the light blocking layer 560 to compensate a height difference between the color filter parts 570 and the light blocking layer 560. The common electrode 590 is formed on the overcoating layer 580.

Light incident on a first conductive lattice pattern 440 of the first substrate 401 is polarized so that a P-polarized light is incident into the liquid crystal layer LC. When the liquid crystal layer LC is twisted, the P-polarized light passes through the liquid crystal layer LC to be changed to an S-polarized light. The S-polarized light passes the common electrode 590, the overcoating layer 580 and the color filter parts 570 to be incident on the second conductive lattice pattern 540.

When the first conductive lattice pattern 440 is arranged in a cross-Nicol arrangement with respect to the second conductive lattice pattern 540, a portion of the S-polarized light passes through a fourth surface 513 of the upper base substrate 510, and a remaining portion of the S-polarized light is reflected on the fourth surface 513 to becomes a randomly polarized light having a P-polarization component. The randomly polarized light having the P-polarization component is again incident on the third surface 511. A portion of the randomly polarized light having the P-polarization component is absorbed by the second light absorbing pattern 530. Thus, an undesired P-polarization component of the light exiting through the fourth surface 513 may be reduced.

When the liquid crystal layer LC is not twisted, the P-polarized light passes through the liquid crystal layer LC. The polarization axis of the P-polarized light is not changed while the P-polarized light passes through the liquid crystal layer LC. The P-polarized light is reflected by the second conductive lattice pattern 540 arranged in the cross-Nicol with respect to the first conductive lattice pattern 440.

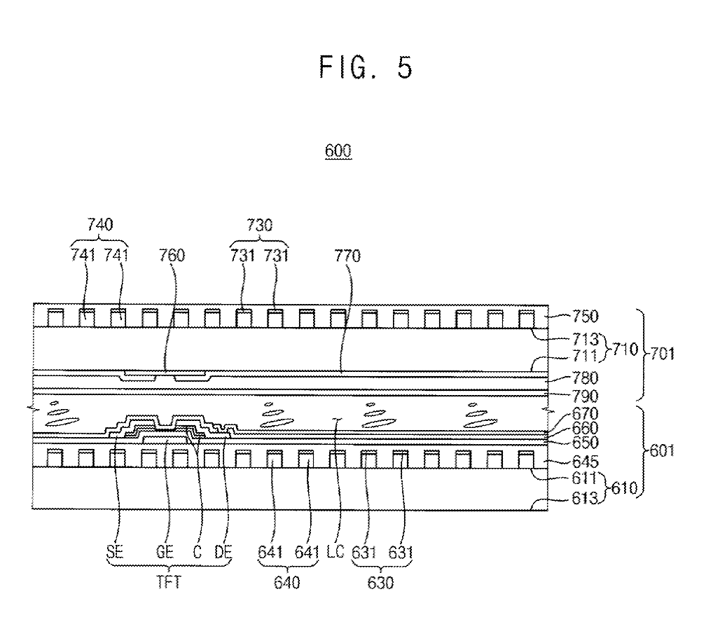

FIG. 5 is a cross-sectional view illustrating a display panel according to an exemplary embodiment of the present invention.

Referring to FIG. 5, a display panel 600 includes a first substrate 601, a second substrate 701 and a liquid crystal layer LC.

The display panel 600 is substantially the same as the display panel illustrated in FIG. 3 except for the first substrate 601.

The first substrate 601 includes a lower base substrate 610, a first light absorbing pattern 630: a first conductive lattice pattern 640: a first planarizing layer 645, a switching device TFT a passivation layer 660 and a pixel electrode 670. The first substrate 601 is substantially the same as the first substrate illustrated in FIG. 3 except for dispositions of the first light absorbing pattern 630, the first conductive lattice pattern 640 and the first planarizing layer 645.

In an embodiment, the first light absorbing pattern 630 is arranged in a stripe shape and is formed on a first surface 611 of the lower base substrate 610. The first conductive lattice pattern 640 is disposed between the first surface 611 and the first light absorbing pattern 630.

The first planarizing layer 645 covers the first light absorbing pattern 630.

The switching device TFT, the passivation layer 660 and the pixel electrode 670 are substantially the same as those illustrated in FIG. 3.

A randomly polarized light is incident on the first surface 611 through a second surface 613 of the lower base substrate 610. A portion of the randomly polarized light is polarized to become a P-polarized light. A remaining portion of the randomly polarized light is reflected on the first surface 611. A portion of the P-polarized light is transmitted through the pixel electrode 670. A remaining portion of the P-polarized light is repeatedly reflected on interfaces among the first planarizing layer 645, the gate insulating layer 650, the passivation layer 660 and the pixel electrode 670 to become a randomly polarized light having an S-polarization component. The first light absorbing pattern 630 formed on the first conductive lattice pattern 640 absorbs a portion of the randomly polarized light having the S-polarization component. Thus, an undesired polarization component exiting through the pixel electrode 670′ i.e. the S-polarization component, may be reduced.

When the first conductive lattice pattern 640 is arranged in a cross-Nicol with respect to a second conductive lattice pattern 740, the P-polarized light exited through the pixel electrode 670 passes through the twisted liquid crystal layer LC to become an S-polarized light. The S-polarized light passes through the second conductive lattice pattern 740. A portion of the S-polarized light is reflected on a surface of a second planarizing layer 750 to become a randomly polarized light having a P-polarization component. The second light absorbing pattern 730 absorbs a portion of the randomly polarized light having the P-polarization component. Thus, an undesired polarization component exiting through the second planarizing layer 750 may be reduced.

Furthermore, the S-polarized light that is an undesired polarization component is incident into the liquid crystal layer LC through the first substrate 610. The S-polarized light passes through the liquid crystal layer LC to become the P-polarized light. The P-polarized light is reflected by the second conductive lattice pattern 740. Thus the P-polarization component of the light exiting through the second planarizing layer 750 may be reduced.

When the liquid crystal layer LC is not twisted, a polarization axis of the P-polarized light incident into the liquid crystal layer LC is not changed while the P-polarized light passes through the liquid crystal layer LC. Thus, the P-polarized light is reflected by the second conductive lattice pattern 740.

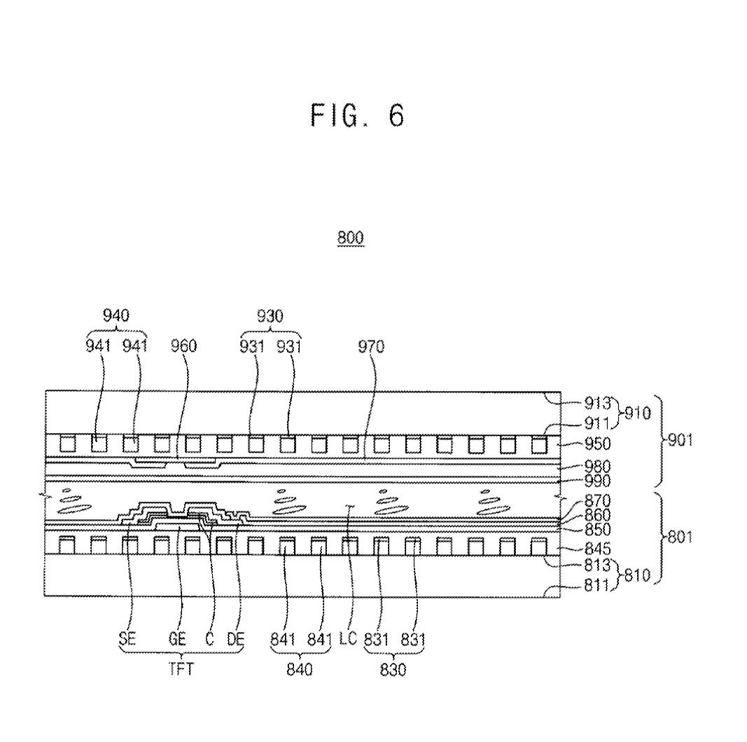

FIG. 6 is a cross-sectional view illustrating a display panel according to an exemplary embodiment of the present invention.

Referring to FIG. 6, a display panel 600 includes a first substrate 801, a second substrate 901 and a liquid crystal layer LC.

The display panel 800 is substantially the same as the display panel illustrated in FIG. 5 except for the second substrate 901. The second substrate 901 is substantially the same as the second substrate illustrated in FIG. 4.

In the embodiments illustrated in FIGS. 3 to 6, the first substrates 201, 401, 601 and 801 respectively include the first conductive lattice patterns 240, 440, 640 and 840, and the second substrates 301, 501, 701 and 901 respectively include the second conductive lattice patterns 340, 540, 740 and 940. Alternatively, the first conductive lattice patterns 240, 440, 640 and 840 and the second conductive lattice patterns 340, 540, 740 and 940 may be selectively replaced with a conventional polarizing plate.

Method of Manufacturing a Polarizing Plate

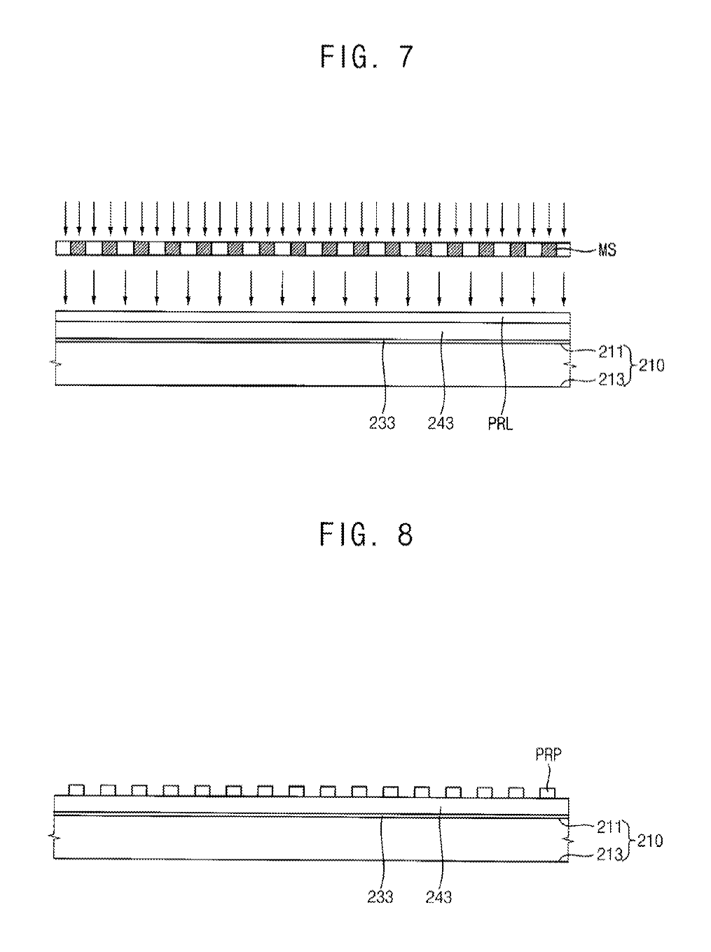

FIGS. 7, 8, 9 and 10 are cross-sectional views illustrating a method of manufacturing a polarizing plate according to an exemplary embodiment of the present invention.

Referring to FIGS. 7 to 10, a method of manufacturing a polarizing plate includes forming a light absorbing layer 233 on a base substrate 210, forming a conductive layer 243 on the light absorbing layer 233, forming a photoresist pattern PRP having a stripe shape on the conductive layer 243 and etching the conductive layer 243, and forming the light absorbing layer 233 using the photoresist pattern PRP as a mask to form a conductive lattice pattern 240 and a light absorbing pattern 230, which corresponds to the photoresist pattern PRP.

A polarizing plate manufactured by the method of manufacturing a polarizing plate according to an exemplary embodiment of the present invention is substantially the same as the first substrate illustrated in FIG. 3 from which the switching device, the passivation layer and the pixel electrode are removed. Thus, any further explanation concerning the same elements wilt be omitted.

Referring to FIG. 7, the light absorbing layer 233 is formed on a first surface 211 of the base substrate 210 including, for example, glass. The light absorbing layer 233 may include a metal of which an optical density is no less than 3.5, for example, chrome (Cr) and/or a carbon-based organic material. Alternatively, the light absorbing layer 233 may include a pigment capable of absorbing light. The thickness of the light absorbing layer 233 may be about 10 to about 100 nm.

A conductive layer 243 is formed on the light absorbing layer 233. The conductive layer 243 may include, for example, a metal having a relatively high reflectivity such as aluminum (Al), aluminum-neodymium (Al—Nd), aluminum-molybdenum (Al—Mo), silver (Ag), copper (Cu), gold (Au) and/or molybdenum (Mo). The conductive layer 243 may be formed through a sputtering process and/or a plating process. The thickness of the conductive layer 243 may be hundreds of nano-meter, for example, about 200 to about 400 nm. When the conductive layer 243 is formed through the sputtering process, the conductive layer 243 may be preferably formed at a relatively low temperature in order to prevent and/or reduce a thermal damage of the base substrate 210.

The photoresist pattern PRP is formed on the conductive layer 243. Particularly, a photoresist layer PRL is formed on the conductive layer 243 and then exposed to light using a mask MS. Referring to FIG. 8, an exposed portion or a non-exposed portion of the photoresist layer PRL is removed through a developing process to form the photoresist pattern PRP corresponding to the conductive lattice pattern 240.

In an embodiment, the photoresist pattern PRP is formed through a photolithography process. Alternatively, the photoresist pattern PRP may be formed through a laser interference lithography process.

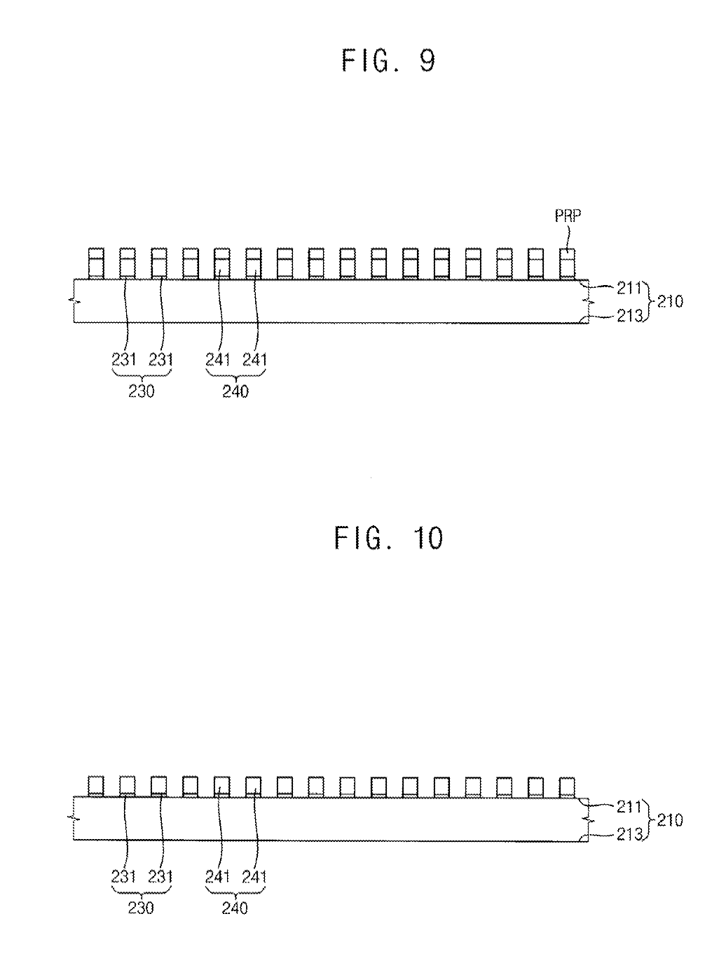

The conductive layer 243 and the light absorbing layer 233 are etched using the photoresist pattern PRP as a mask. The conductive layer 243 and the light absorbing layer 233 may be simultaneously etched through a dry etching process. As a result, the conductive lattice pattern 240 having a stripe shape and the light absorbing pattern 230 having a stripe shape are formed as illustrated in FIG. 9. The conductive lattice pattern 240 has a plurality of lattice lines 241 disposed substantially parallel to each other. The light absorbing pattern 230 has a plurality of light absorbing portions 231 corresponding to the lattice lines 241. A width and a pitch of the lattice lines 241 are substantially the same as those of the light absorbing portions 231.

Referring to FIG. 10, the photoresist pattern PRP remaining on the conductive lattice pattern 240 is removed through a stripping process to manufacture the polarizing plate.

Alternatively the light absorbing layer 233 may be formed after the conductive layer 132 is formed. Thus, the light absorbing pattern 230 may be formed on the conductive lattice pattern 240.

According to the above, a light absorbing pattern absorbs a portion of a randomly polarized light that is reflected on an interface to be incident on the light absorbing pattern after being polarized by a conductive lattice pattern. Thus, an undesired polarization component of a light exiting through a polarizing plate may be reduced. Thus, a contrast ratio of a display panel having the polarizing plate may be improved. Furthermore, a polarizing plate and/or a dual brightness enhancement film applied to the display panel may be replaced with a substrate having the conductive lattice pattern, thereby reducing a manufacturing cost of the display panel.

Although the illustrative embodiments of the present invention have been described herein with reference to the accompanying drawings it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A polarizing plate comprising:
a base substrate having a first surface and a second surface located opposite to the first surface,
a conductive lattice pattern formed on the first surface, the conductive lattice pattern reflecting and polarizing a light incident on the conductive lattice pattern; and
a light absorbing pattern formed on the first surface and corresponding to the conductive lattice pattern, wherein the light absorbing pattern absorbs at least a portion of a reflected light after being polarized by the conductive lattice pattern.

2. The polarizing plate of claim 1, wherein the light absorbing pattern is disposed between the first surface and the conductive lattice pattern.

3. The polarizing plate of claim 1, wherein the conductive lattice pattern is disposed between the first surface and the light absorbing pattern.

4. The polarizing plate of claim 3, wherein the conductive lattice pattern is formed in a stripe arrangement.

5. The polarizing plate of claim 1, wherein a thickness of the light absorbing pattern is about 10 to about 100 nm.

6. The polarizing plate of claim 1, wherein the conductive lattice pattern comprises a plurality of lattice lines, and a pitch and a width of the lattice lines adjacent to each other are in a range of about 100 to about 200 nm.

7. A polarizing plate comprising:
a base substrate having a first surface and a second surface that is opposite to the first surface;
a light absorbing layer formed on the first surface, a thickness of the light absorbing layer being in a range of about 10 to about 100 nm; and
a conductive lattice pattern formed on the light absorbing layer in a stripe arrangement.

8. A display panel comprising:
a first substrate comprising:
a lower base substrate, the lower base substrate including a first surface and a second surface that is located opposite to the first surface;
a first conductive lattice pattern formed on the lower base substrate in a stripe arrangement to reflect and polarize light incident on the first conductive lattice pattern;
a first light absorbing pattern formed on the lower base substrate, wherein the first light absorbing pattern corresponds to the first conductive lattice pattern; and
a plurality of pixels formed on the lower base substrate;
a second substrate comprising:
an upper base substrate including a third surface and a fourth surface located opposite to the third surface;
a plurality of color filter parts formed on the upper base substrate and corresponding to the pixels; and
a liquid crystal layer interposed between the first substrate and the second substrate.

9. The display panel of claim 8 wherein the second substrate further comprises;
a second conductive lattice pattern formed on the upper base substrate and in a stripe arrangement, the second conductive lattice pattern reflecting and polarizing light incident on the second conductive lattice pattern; and
a second light absorbing pattern that is formed on the upper base substrate and corresponds to the second conductive lattice pattern.

10. The display panel of claim 9, wherein the pixels are formed on the first surface, the first conductive lattice pattern is formed on the second surface, and the first light absorbing pattern is disposed between the second surface and the first conductive lattice pattern.

11. The display panel of claim 10, wherein the color filter parts are formed on the third surface, the second conductive lattice pattern is formed on the fourth surface, and the second light absorbing pattern is disposed between the fourth surface and the second conductive lattice pattern.

12. The display panel of claim 10, wherein the second substrate further comprises a planarizing layer to cover the second conductive lattice pattern the second conductive lattice pattern is formed on the third surface, the second light absorbing pattern is disposed between the third surface and the second conductive lattice pattern, and the color filter parts are formed on the planarizing layer.

13. The display panel of claim 9, wherein the first substrate further comprises a planarizing layer to cover the first light absorbing pattern, the first light absorbing pattern is formed on the first surface, the first conductive lattice pattern is disposed between the first surface and the first conductive lattice pattern, and the pixels are formed on the planarizing layer.

14. The display panel of claim 13, wherein the color filter parts are formed on the third surface, the second light absorbing pattern is formed on the fourth surface, the second conductive lattice pattern is disposed between the fourth surface and the second light absorbing pattern.

15. The display panel of claim 13, wherein the second substrate further comprises a planarizing layer to cover the second conductive lattice pattern, a second conductive lattice pattern is formed on the third surface, the second light absorbing pattern is disposed between the third surface and the second conductive lattice pattern, and the color filter parts are formed on the planarizing layer.

16. A method of manufacturing a polarizing plate, the method comprising:
forming a light absorbing layer on a base substrate;
forming a conductive layer on the light absorbing layer;
forming a photoresist pattern in a stripe arrangement on the conductive layer; and
etching the conductive layer and the light absorbing layer using the photoresist pattern as a mask to form a conductive lattice pattern and a light absorbing pattern.

17. The method of claim 16, wherein forming the photoresist pattern is performed through a photolithography process or a laser interference lithography process.
